(19) United States
(12) Patent Application Publication
(10) Pub. No.: US 2010/0131943 A1
(43) Pub. Date: May 27, 2010

(54) METHOD AND SYSTEM FOR OPTIMIZING APPLICATION DEPLOYMENT IN OPEN SERVICE GATEWAY INITIATIVE FRAMEWORK

(75) Inventors: Siddapur Channakeshava Sreekanth, Bangalore (IN); Vedula Kiran Bharadwaj, Bangalore (IN)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/626,240

(22) Filed: Nov. 25, 2009

(30) Foreign Application Priority Data
Nov. 27, 2008 (IN) 2981/CHE/2008

(51) Int. Cl. G06F 9/445

(52) U.S. Cl. 717/176

(57) ABSTRACT

Systems and methods for optimizing application deployment in an open service gateway initiative framework. A method includes receiving a check dependency message from an electronic device, checking for dependency on the open service gateway initiative framework, and generating a resolve status. The application is deployed based on the resolve status, and a command response is generated based on the deployment, and the transmitted to the electronic device.

### PRIORITY

This application claims priority under 35 U.S.C.§119(a) to an application filed in the Indian Patent Office on Nov. 27, 2008 and assigned Serial No. 2981/CHE/2008, the content of which is incorporated herein by reference.

### BACKGROUND OF THE INVENTION

1. Field of the Invention

The present invention relates generally to an Open Service Gateway initiative (OSGi) framework, and more particularly to application deployment in an OSGi framework.

2. Description of the Related Art

OSGi framework acts as a gateway between a network and a plurality of electronic devices. An electronic device uses the OSGi framework as a storage medium, an execution medium, and to run applications to support the electronic devices. The OSGi framework can be used to download applications requested by the electronic devices. Further, the OSGi framework may download the applications without appropriate information on the applications. However, under certain circumstances the OSGi framework may be overloaded or may not support the requested applications.

### SUMMARY OF THE INVENTION

The present invention is designed to substantially solve at least the above problems and/or disadvantages and to provide at least the advantages described below. Accordingly, an aspect of the present invention is to provide methods and systems for optimizing application deployment in an OSGi framework.

In accordance with an aspect of the present invention, a method for optimizing application deployment in open service gateway initiative framework includes receiving a check dependency message from an electronic device, checking for dependency on the open service gateway initiative framework and generating a resolve status, deploying the application based on the resolve status, generating a command response based on the deployment, and transmitting the generated command response to the electronic device.

In accordance with another aspect of the present invention, an Open Service Gateway Initiative (OSGi) framework for optimizing application deployment includes a check unit for checking dependency of an application, a status generation unit for generating a resolve status, and a command generation unit for generating a command response.

### BRIEF DESCRIPTION OF THE DRAWINGS

The above and other aspects, features, and advantages of the present invention will become more apparent from the following detailed description when taken in conjunction with the accompanying drawings in which:

FIG. 1 is a block diagram illustrating an environment for implementing an OSGi framework in accordance with an embodiment of the present invention;

FIG. 2 is a block diagram of an electronic device, in accordance with an embodiment of the present invention;

FIG. 3 is a block diagram of an OSGi framework, in accordance with an embodiment of the present invention; and

FIG. 4 is a flowchart illustrating a method for optimizing application deployment in an OSGi framework, in accordance with an embodiment of the present invention.

### DETAILED DESCRIPTION OF EMBODIMENTS OF THE INVENTION

Certain embodiments of the present invention are described in detail below, with reference to the accompanying drawings. The same or similar components may be designated by the same or similar reference numerals although they are illustrated in different drawings. Detailed descriptions of constructions or processes known in the art may be omitted to avoid obscuring the subject matter of the present invention. Terms described below, which are defined considering functions in accordance with the embodiments of the present invention, may be different depending on user and operator intention or practice. Therefore, the terms should be defined on the basis of the disclosure throughout this specification.

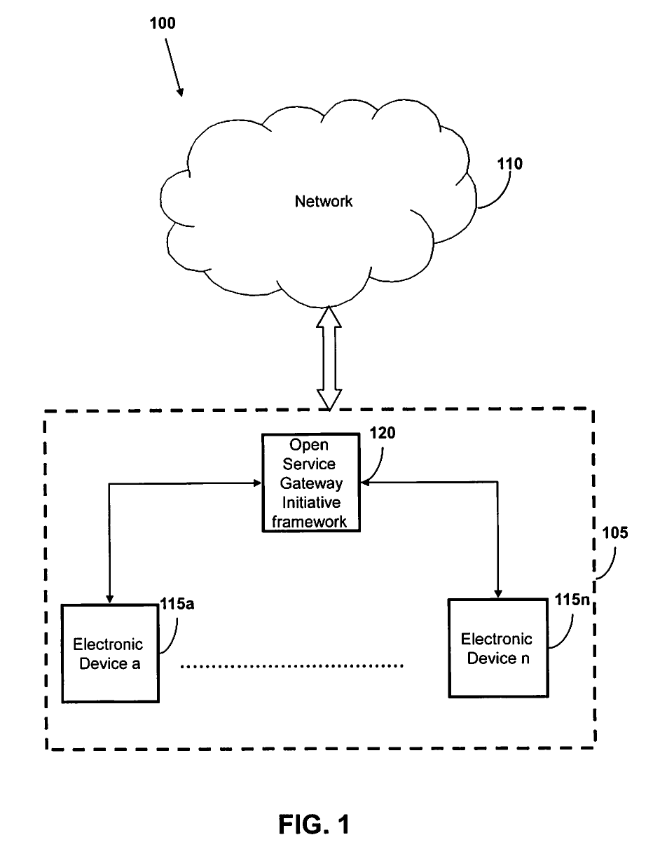

FIG. 1 is a block diagram illustrating an environment 100 for implementing an OSGi framework, in accordance with an embodiment of the present invention. The environment 100 includes, but not limited to, a local network or system 105. The local network 105 includes electronic devices 115a to 115n and an Open Service Gateway Initiative (OSGi) framework 120. Examples of the electronic device 115a include, but are not limited to, a computer, a laptop, a palmtop, a mobile telephone, a washing machine, an automated lighting system, a Personal Digital Assistant (PDA), a television, a music player, a microwave oven, and a security alarm.

The local network 105 is in a service communication with a network 110. Examples of the network 110 include, but are not limited to, a Local Area Network (LAN), a Wireless Local Area Network (WLAN), a Wide Area Network (WAN), Internet and a Small Area Network (SAN).

In accordance with an embodiment of the present invention, the OSGi framework 120 is in service communication with the network 110.

In accordance with another embodiment of the present invention, the electronic devices 115a to 105n are in service communication with the network 110. Examples of the service communication include, but are not limited to, LAN, WLAN, Internet, SAN, Bluetooth, infrared, Wireless Fidelity (Wi-Fi), and Universal Plug and Play (UPnP).

In accordance with an embodiment of the present invention, the communication protocol can be on a pre-defined structure. Examples of the pre-defined structure include, but are not limited to, an eXtensible Markup Language (XML) file format, Hyper Text Transfer Protocol (HTTP) message, and a bundle Meta manifest file.

In accordance with another embodiment of the present invention, the communication protocol can be on an auto mode structure.

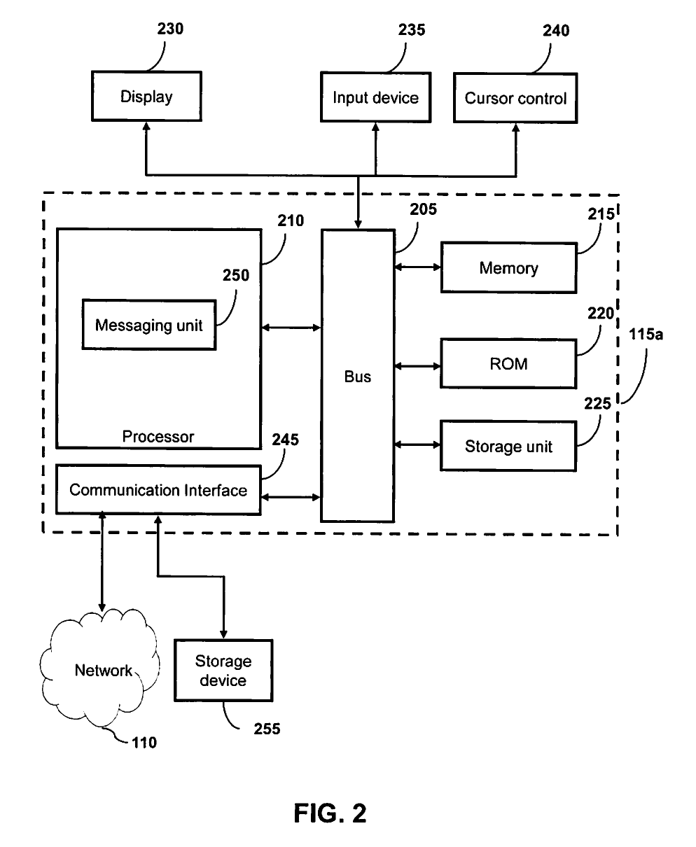

The electronic device 115a includes at least one element for optimizing application deployment in an OSGi framework. More specifically, the electronic device 115a including elements will be described in more detail below in conjunction with FIG. 2.

FIG. 2 is a block diagram of the electronic device 115a, in accordance with an embodiment of the present invention. The electronic device 115a includes a bus 205 or other communication mechanism for communicating information, and a processor 210 coupled with the bus 205. The processor 210 may include an integrated electronic circuit for processing and controlling functionalities of the electronic device 115a.

The electronic device 115a also includes a memory 215, such as a Random Access Memory (RAM) or other dynamic storage device, coupled to the bus 205 for storing information, which can be used by the processor 210. The memory 215 can be used for storing any temporary information.

The electronic device 115a also includes a Read Only Memory (ROM) 220 or other static storage device coupled to the bus 205 for storing static information for the processor 210. Additionally, a storage unit 225, such as a magnetic disk or optical disk, is provided and coupled to the bus 205 for storing information.

The electronic device 115a may be coupled via the bus 205 to a display 230, such as a Cathode Ray Tube (CRT), a Liquid Crystal Display (LCD) or a Light Emitting Diode (LED) display, for displaying information. An input device 235, including alphanumeric and other keys, is coupled to the bus 205 for communicating an input to the processor 210. Although shown separate from the electronic device 115a, the input device can be included in the electronic device 115a. Another user input device for cursor control 240, such as a mouse, a trackball, or cursor direction keys, is provided for communicating the input to the processor 210 and for controlling cursor movement on the display 230. The input device 235 can also be included in the display 230, for example, a touch screen.

In accordance with an embodiment of the present invention, certain processes are performed by the processor 210 using information included in the memory 215. The information can be read into the memory 215 from another machine-readable medium, such as the storage unit 225.

The term “machine-readable medium” as used herein refers to any medium that is able to provide data that causes a machine to operate in a specific fashion.

In accordance with an embodiment of the present invention, various machine-readable mediums are involved, for example, in providing information to the processor 210. The machine-readable medium can be a storage media. Storage media includes both non-volatile media and volatile media. Non-volatile media includes, for example, optical or magnetic disks, such as the storage unit 225. Volatile media includes dynamic memory, such as the memory 215. All such media is tangible, such that it enables the information carried by the media to be detected by a physical mechanism that reads the information into a machine.

Common forms of machine-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In accordance with another embodiment of the present invention, the machine-readable medium can be a transmission media including coaxial cables, copper wire and fiber optics, including the wires that include the bus 205. Transmission media can also take the form of acoustic or light waves, such as those generated during radio-wave and infra-red data communications.

The electronic device 115a includes a communication interface 245 coupled to the bus 205. The communication interface 245 provides a two-way data communication coupling to the network 110. The electronic device 115a communicates with the OSGi framework 120 using the communication interface 245. For example, the communication interface 245 can be a LAN card for providing a data communication connection to a compatible LAN. Wireless links can also be implemented. In any such implementation, the communication interface 245 sends and receives electrical, electromagnetic or optical signals that carry digital data streams representing various types of information. The communication interface 245 can be a universal serial bus port.

The electronic device 115a may be connected to an external storage device 255 for storing or fetching information. Examples of the storage device 255 include, but are not limited to, a flash drive, a pen drive, a hard disk or any other storage media.

The processor 210 may also include one or more processing units, for example, a messaging unit 250. The messaging unit 250 creates a check dependency message to be transmitted to an OSGi framework. The message is used to check for an application dependency prior to the application deployment in the OSGi framework. Examples of the message include, but are not limited to, XML file format, a HTTP message, and a bundle Meta manifest file. Examples of the information in the message include, but are not limited to, link to the application, parameters of the application such as memory requirement, and dependency of the application by the electronic device 115a. The processing units can be hardware circuitry, which performs the desired functions.

The electronic device 115a may not include separate processing units and the functions of the processing units can be performed by the processor 210.

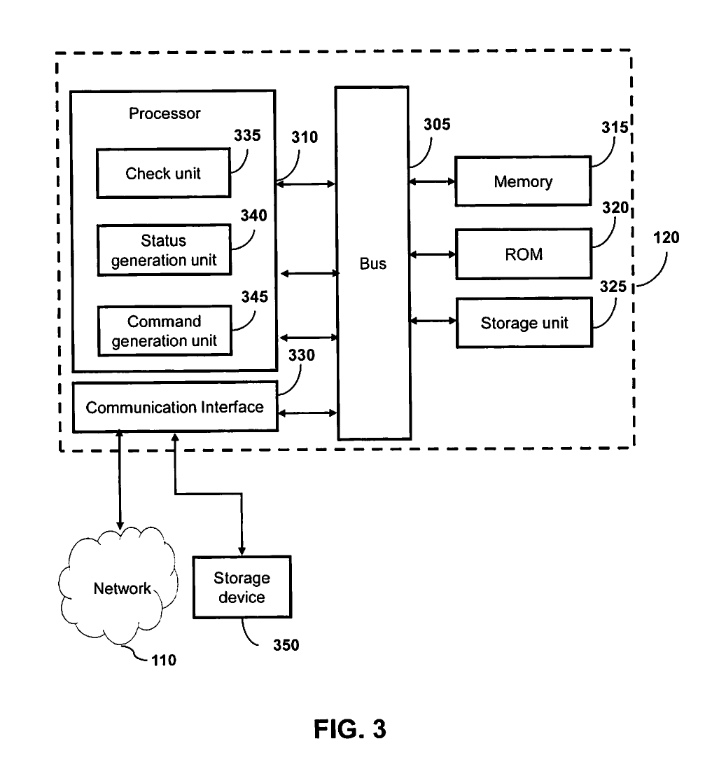

FIG. 3 is a block diagram of the OSGi framework 120, in accordance with an embodiment of the present invention. The OSGi framework 120 includes a bus 305 or other suitable communication mechanism for communicating information, and a processor 310 coupled with the bus 305. The processor 310 may include an integrated electronic circuit for processing and controlling functionalities of the OSGi framework 120.

The OSGi framework 120 also includes a memory 315, such as a RAM or other dynamic storage device, coupled to the bus 305 for storing information used by the processor 310. The memory 315 can be used for storing any temporary information.

The OSGi framework 120 also includes a ROM 320 or other static storage device coupled to the bus 305 for storing static information for the processor 310, and a storage unit 325, such as a magnetic disk or optical disk, which is coupled to the bus 305, for storing information.

In accordance with an embodiment of the present invention, certain processes are performed by the processor 310 using information included in the memory 315. The information can be read into the memory 315 from another machine-readable medium, such as the storage unit 325.

The OSGi framework 120 also includes a communication interface 330 coupled to the bus 305. The communication interface 330 provides a two-way data communication coupling to the network 110. The OSGi framework 120 communicates with the electronic device 115a using the communication interface 330. For example, the communication interface 330 can be a LAN card providing a data communication connection to a compatible LAN. Wireless links can also be implemented. In any such implementation, the communication interface 330 sends and receives electrical, electromagnetic or optical signals that carry digital data streams representing various types of information. The communication interface 330 may also be a universal serial bus port.

The OSGi framework 120 may be connected to an external storage device 350 for storing or fetching information. Examples of the storage device 350 include, but are not limited to, a flash drive, a pen drive, a hard disk or any other storage media.

The processor 310 may include one or more processing units, for example, a check unit 335, a status generation unit 340, and command generation unit 345. The check unit 335 checks dependency of an application and evaluates the application, wherein the evaluation includes requirements for the electronic device, storage requirements in the OSGi framework, priority to the one or more electronic device, priority of one or more applications, processing requirements, network strength for downloading the application, time for downloading the application, etc. The status generation unit 340 generates a resolve status based on the evaluation. The resolve status is transmitted to the electronic device 115a and can be based on, for example, priority of the electronic device, time to resend the check dependency, or status about the OSGi framework 120. The application is deployed based on the resolve status. The command generation unit 345 generates a command response, which is generated and transmitted to the electronic device 105a. The command response provides the status of the application deployment.

The processing units can be hardware circuitry, which performs the desired functions.

Alternatively, the OSGi framework 120 may not include the separate processing units, and the functions of the separate processing units can be performed by the processor 310.

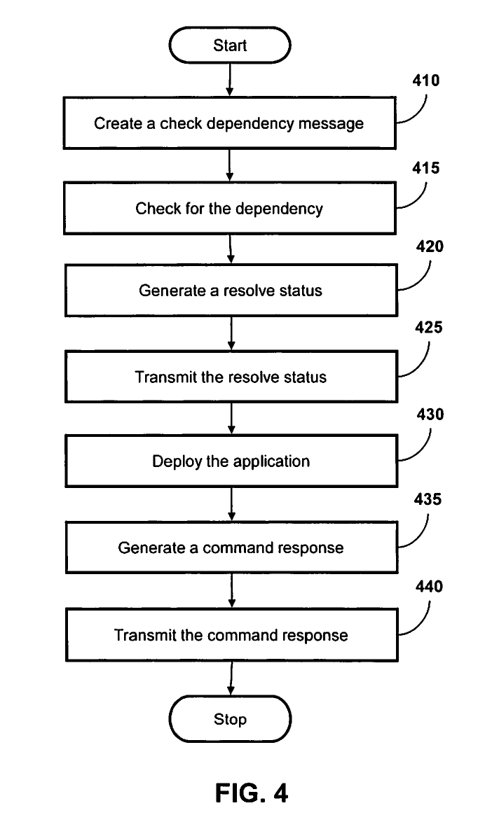

FIG. 4 illustrates a method for optimizing application deployment in an OSGi framework, in accordance with an embodiment of the present invention.

When an application is to be deployed, at step 410, a check dependency message is created by the electronic device for the application to be deployed on the OSGi framework. The check dependency message is created by a messaging unit of the electronic device. Examples of the information included in the message include, but are not limited to, a link to the application, parameters of the application such as a memory requirement, and dependency of the application by the electronic device.

At step 415, the dependency of the application is checked by the OSGi framework, based on the check dependency message. Several parameters may be involved for checking dependency. Examples of parameters invoked for checking the dependency of the application include requirements for the electronic device, storage requirements in the OSGi framework, priorities of electronic devices, priorities of applications, processing requirements, network strength for downloading an application, and a time for downloading the application.

At step 420, a resolve status is generated based on the checking of the dependency. The resolve status, for example, may be based on a priority of the electronic device, a time to resend the check dependency, and status information about the OSGi framework. The resolve status may indicate the electronic device to deploy the application. In accordance with another embodiment of the present invention, the resolve status may indicate the electronic device to deploy the application at a later time.

At step 425, the resolve status is transmitted to the electronic device from the OSGi framework, and at step 430, the application is deployed. if the resolve status indicates the electronic device to deploy the application.

At step 435, a command response is generated based on the deployment of the application, and at step 440, the generated command response is transmitted to the electronic device by the OSGi framework.

Alternatively, the above-described method for optimizing application deployment in an Open Service Gateway initiative (OSGi) framework in accordance with the embodiments of the present invention may be implemented by hardware, software (i.e. a program), or a combination of both. Such a program may be stored in a volatile or nonvolatile recording medium, which can be read by a machine, such as a computer. The recording medium includes a storage device, such as a ROM and the like, memory, such as a RAM, a memory chip, an integrated circuit, and the like, and an optical or magnetic recording medium, such as a CD, a DVD, a magnetic disk, a magnetic tape, and the like. That is, the method for optimizing application deployment in the OSGi framework according to embodiments of the present invention may be implemented in the form of a program, which includes code for achieving the method. Further, such a program may be transferred electrically through a medium, just as a communication signal propagated by wire or wirelessly, the equivalents of which are also included in the scope of the present invention.

Although the present invention has been shown and described with reference to certain embodiments thereof, it will be understood by those skilled in the art that various changes in form and details may be made therein without departing from the spirit and scope of the present invention as defined by the appended claims and their equivalents. Therefore, the scope of the present invention should not be limited to the above-described embodiments but should be determined by the appended claims and any equivalents thereof.

What is claimed is:

1. A method for optimizing application deployment in an Open Service Gateway initiative (OSGi) framework, the method comprising:
receiving a check dependency message from an electronic device;
checking for dependency on the OSGi framework;
generating a resolve status based on a result of the checking;
deploying the application based on the resolve status;
generating a command response based on the deployment; and
transmitting the generated command response to the electronic device.

2. The method of claim 1, further comprising transmitting the resolve status to the electronic device.

3. The method of claim 1, wherein checking for the dependency comprises:
checking for requirements of the application to be deployed.

4. The method of claim I, wherein generating the resolve status is further based on requirements of the application to be deployed.

5. The method of claim 1, wherein deploying the application comprises:
prioritizing the application to be deployed based on the resolve status.

6. A system for optimizing application deployment in an Open Service Gateway initiative (OSGi) framework, the system comprising:
a check unit for checking dependency of an application;
a status generation unit for generating a resolve status based on a result of the checking; and
a command generation unit for generating a command response.

7. The system of claim 6, further comprising an electronic device including a messaging unit for creating a check dependency message.
